(19) United States
(12) Patent Application Publication
(10) Pub. No.: US 2003/0102308 A1
(43) Pub. Date: Jun. 5, 2003

(54) Temporary protective cover for electrical outlet receptacle

(76) Inventor: Joseph Sullivan, Forrestdale, MA (US)

Correspondence Address: MORSE, ALTMAN & MARTIN, P.O. BOX 6926, BOSTON, MA, 02102, US

(21) Appl. No.: 10/337,652

(22) Filed: Jan. 7, 2003

Related U.S. Application Data
(63) Continuation-in-part of application No. 09/943,455, filed on Aug. 30, 2001, now Pat. No. 6,520,363.

(51) Int. Cl. H02G 3/08

(52) U.S. Cl. 220/3.2

(57) ABSTRACT

An electrical receptacle shield in the form of a folded thin sheet metal stamping is provided. This shield temporarily covers the front opening of an outlet receptacle. Within the receptacle is electrical wiring and a manual switch that must be protected from any cutting instrument that is used during a installation process. The peripheral wall of the receptacle has a plurality of inwardly directed tabs having forward faces that lie in the plane of the rim of the peripheral wall, and that have openings for the reception of screws by which a finish plate may be secured to the outlet receptacle after its front opening is exposed through the drywall. The shield is in the form of a folded metal sheet that has an inner base section lying in a plane, and pair of inwardly bent, opposed flanges that, in effect, are spring biased outwardly. The arrangement is such that first the flanges can be pressed toward each other, next fitted into the front opening of the outlet receptacle at its walls, and then pressed into the receptacle until a part of the base buts against the tabs and the shield is held in position within the receptacle by the outward spring bias of the flanges. A drill or saw then may be eased into a blind position at the perimeter of the receptacle to cut an opening in a dry wall to expose the receptacle.

### BACKGROUND OF THE INVENTION

1. Field of the Invention

The present invention relates to the protection of electrical outlet receptacles during installation, and, more particularly, to temporary shields for protecting the contents of electrical outlet receptacles during installation. Typically, such outlet receptacles first are nailed or otherwise affixed to wall studs while exposed, next sheet rock or other drywall is nailed to the wall studs in front of the outlet receptacle, and then an opening is cut into the drywall to expose the front of the receptacle and to deploy a manual switch or the like. Finally, a finish plate is affixed to the outlet receptacle to cover the open front of the receptacle while providing access to the switch.

2. The Prior Art

Determining the proper location of the opening in front of the outlet receptacle has been a problem. As previously suggested, outlet receptacles are nailed or otherwise secured to wall support studs and are wired before a drywall or the like is nailed or stapled to the support studs. An outlet receptacle is located by tapping or punching the drywall, after which an opening that matches the perimeter of the outlet receptacle is cut with a rotary drill or a saber saw using the periphery of the outlet receptacle as a guide. Damage to the electrical wiring within the outlet receptacle often occurs. A variety of prior art shields have been proposed to protect the contents of outlet receptacles during the construction process. Such shields in the past typically have been inconvenient to carry and unwieldy to use because of their unnecessarily rugged and complex construction. Furthermore, their complex construction often has hindered rather than helped cutting an appropriate opening in an associated drywall. There is a need for a simplified, lightweight and inexpensive outlet shield that can be readily located behind a dry wall and that can be used effectively as a guide for cutting an opening that matches the opening of the outlet receptacle.

### SUMMARY OF THE INVENTION

The primary object of the present invention is to provide an electrical receptacle shield in the form of a folded thin sheet metal stamping, a supply of which may be readily stacked and carried. This shield is designed to temporarily but effectively cover the front opening of an outlet receptacle that is characterized by a back wall and a peripheral wail bounding the back wall and the front opening. Within the receptacle is electrical wiring and a manual switch that must be protected from any cutting instrument that is used during an installation process. The peripheral wall of the receptacle has free front edges of predetermined thickness, which may be considered to lie in a plane and to define a front rim. The peripheral wall has a plurality of inwardly directed tabs having foreword faces that lie in the plane of the rim of the peripheral wall, and that have openings for the reception of screws by which a finish plate may be secured to the outlet receptacle after its front opening is exposed through the drywall. A precise geometrical description of the shield is necessary for an understanding of the present invention. Specifically, the shield is in the form of a folded metal sheet that has an inner base section lying in a plane, and a plurality of inwardly bent, opposed flanges that, in effect, are spring biased outwardly. The arrangement is such that first the flanges can be pressed toward each other against their spring bias, next are fitted into the front opening of the outlet receptacle at its walls, and then are pressed into the receptacle until a part of the base buts against the tabs and the shield is held in position within the receptacle by the outward spring bias of the flanges. The arrangement is such that the a drill or saw may be eased into a blind position at the perimeter of the receptacle to cut an opening in a dry wall in front of the receptacle. Thereafter, the shield can be pried from the receptacle through the opening that has been cut to provide access to a manual switch and to permit association with a finish plate through which the switch is accessible.

### BRIEF DESCRIPTION OF THE DRAWINGS

For a fuller understanding of the nature and objects of the present invent-on, reference is made to the following description, which is to taken in connection with the accompanying drawings, wherein:

FIG. 1 is a perspective view of an electrical receptacle in accordance with the present invention;

FIG. 2 shows a shield embodying the present invention;

FIG. 3 is a view of the receptacle and shield after the shield has been deployed within the receptacle;

FIG. 4 shows a circular shield for deployment in a circular electrical receptacle in accordance with the present invention.

### DETAILED DESCRIPTION OF PREFERRED EMBODIMENTS

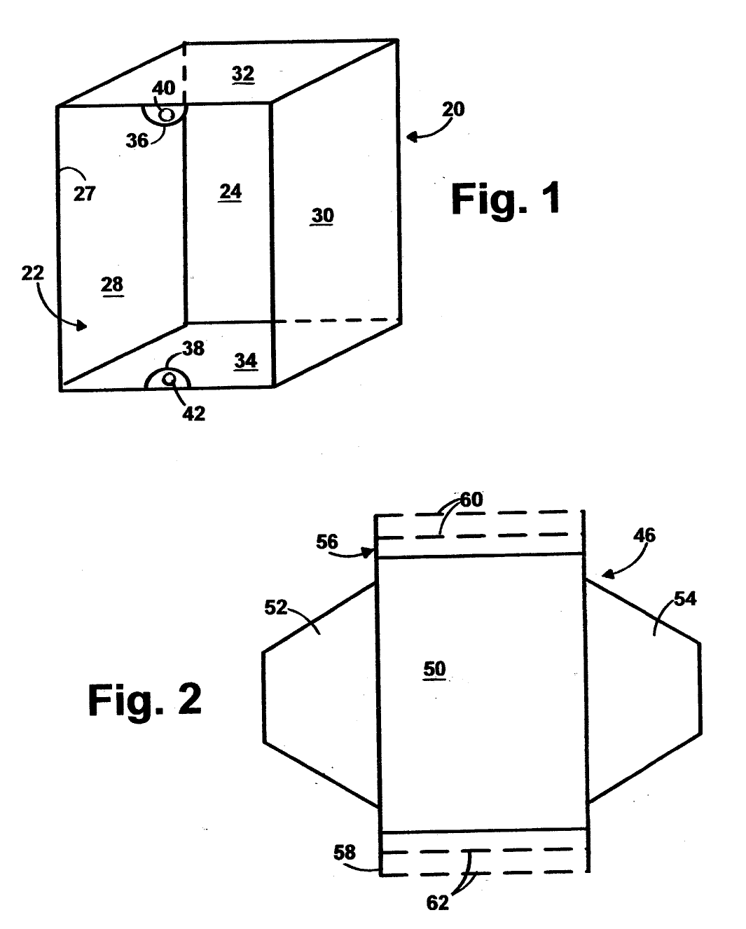

FIG. 1 shows a standard electrical utility or outlet box 20 having a front opening 22, a back wall 24, and peripheral walls that include opposed vertical sections 28, 30 and opposed horizontal top and bottom sections 32, 34. The peripheral walls have free front edges 27 of predetermined thickness, which may be considered to lie in a plane and to define a front profile. The opposed top and bottom sections 32, 34 of the peripheral walls have a pair of inwardly directed tabs 36, 38 that have forward faces lying in the plane of the free front edges 27 of the peripheral wall. These tabs have threaded holes 40, 42 for the reception of screws by which a finish plate may be secured to the front face of the outlet receptacle after its front opening is exposed through the drywall.

In accordance with the present invention, a shield 46 is in the form of a thin sheet metal stamping, composed, for example, of 16 to 18 gauge mild steel. Shield 46 includes a base section 50 and a pair of opposed flanges 52, 54, which are integral therewith. This construction and composition provides the flanges with a spring-like character, by which they may be biased against the inner surfaces of the outlet receptacle's walls when the shield is in use. A supply of stacked shields can be carried easily in a worker's pocket. As shown, base section 50 has upper and lower extensions 56, 58, which are separated from the remainder of the base section by scores 60,62. Bending the extensions at selected scores causes detachment of selected portions of the base from the remainder for the purpose of adjusting the size of the base to accommodate electrical outlets of different sizes.

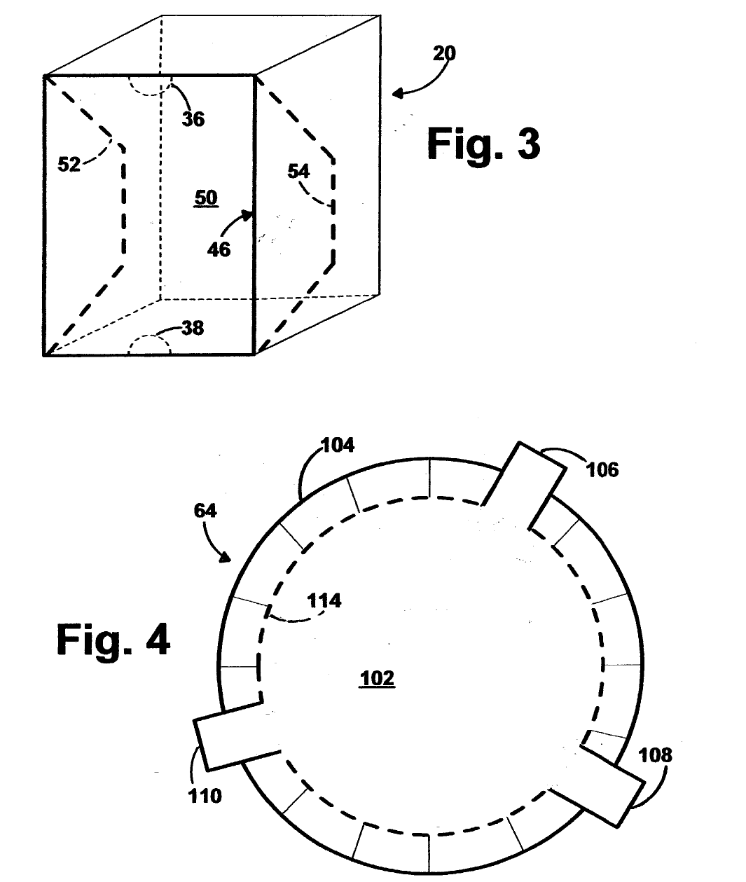

As shown in FIG. 3, the arrangement is such that, with the flanges of the shield pressed toward each other and the base of the shield pressed into contact with tabs 38, 40, the shield may be held in position by the flanges, which are spring biased against the receptacle's interior walls 28, 30. After use, the shield can be pried from the receptacle by a screwdriver for replacement by finish plate.

FIG. 12 illustrates a circular shield 64 having an inner base section 102, an outer rim section 104, and a plurality of flanges 106, 108, 110. Pursuant to the present invention, outer rim section 104 consists of a plurality of separate sections 112 that are separated from inner base section 102 by scores 114. Bending at the scores enables removal of the outer rim section for adjustment of size. When base section 102 is pressed into a circular electrical receptacle, flanges 106, 108 and 110 are capable of pressing against the interior surface of the receptacle while inward movement of base section 102 is limited by suitable tabs in the receptacle.

### Operation

In operation, a shield is press fitted into an outlet receptacle, which typically is nailed to one of a series of wall studs. The shield is retained in position by flanges, which clutch the inner surfaces of the walls of the outlet receptacle. Thereafter, a drywall is nailed to the wall studs in front of the outlet box. The location of the shield, together with the location of the outlet box then is detected by probing with a sharp instrument. For safety, a cutting drill is guided carefully into contact with the base section of the shield, and then into contact with the perimeter of the outlet to cut an opening in the drywall. A finish plate then is secured in position by screws, which are turned into holes in the tabs.

What is claimed is:

1. A shield for temporarily covering the front opening of an electrical receptacle that has a back wall, peripheral walls bounding said back wall and said front opening, tabs extending from said peripheral walls at said front opening, and electrical wiring within said receptacle;
(a) said shield comprising a base section and opposed flange sections extending rearwardly from said base section;
(b) said shield being moveable between an internal position substantially within said receptacle and external positions outside of said receptacle;
(c) said flanges and said base having an integral configuration and being biased into said configuration by the modulus of elasticity of the material of which said shield is composed;
(d) said tabs limiting movement of said shield into said receptacle when said shield is being inserted into said internal position;
(e) said base substantially covering said opening and said flanges being spring pressed against the inner faces of said peripheral wall when said shield is in said internal position;
(f) said shield being removable from said receptacle.

2. The shield of claim 1 wherein the profile of the rim of said receptacle is rectangular.

3. The shield of claim 1 wherein the profile the rim of the receptacle circular.

4. The shield of claim 1 wherein said shield is a stamping composed of 16 to 18 gauge mild steel.
